(19) United States
(12) Patent Application Publication
(10) Pub. No.: US 2022/0126255 A1
(43) Pub. Date: Apr. 28, 2022

(54) METHODS FOR BLOCKING HEAVY METALS FROM ENTERING PLANT EXTRACTS

(71) Applicant: Treestar Capital Corp., Calgary (CA)

(72) Inventor: Richard Bueble, Calgary (CA)

(21) Appl. No.: 17/508,216

(22) Filed: Oct. 22, 2021

(30) Foreign Application Priority Data
Oct. 23, 2020 (CA) 3096942

(51) Int. Cl. B01J 19/08; B01D 11/02

(52) U.S. Cl. CPC B01J 19/08; B01J 2219/0879; B01D 11/02

(57) ABSTRACT

Disclosed are methods for pretreating a plant material prior to solvent extraction, wherein the methods comprise subjecting a comminuted dried plant material to non-ionizing radiation at an energy input of equal to or greater than about 0.02 kWh per 1 kg of dried plant material. Also disclosed are methods of extracting plant metabolites from a plant material, the methods comprising comminuting a dried plant material, subjecting the comminuted plant material to a non-ionizing radiation at an energy input of equal to or greater than about 0.02 kWh per 1 kg of dried plant material to thereby pretreat the plant material, contacting the pretreated plant material with a solvent, and recovering a solubilized extract therefrom.

### CROSS-REFERENCE TO RELATED APPLICATIONS

This application claims priority to and the benefit of the filing of Canada Patent Application No. 3,096,942, entitled “METHODS FOR BLOCKING HEAVY METALS FROM ENTERING PLANT EXTRACTS”, filed on Oct. 23, 2020, and the specification and claims thereof are incorporated herein by reference.

### TECHNICAL FIELD

This disclosure generally relates to methods for processing plant materials to produce extracts therefrom. More specifically, this disclosure pertains to methods for immobilizing heavy metals in plant materials during processing to minimize and eliminate heavy metals in recovered plant extracts.

### BACKGROUND

It is well known that all plants produce during their growth cycles, a wide variety of primary metabolites that are required for plant growth and development, and typically comprise an array of fatty acids, lipids, amino acids, peptides, enzymes, and carbohydrates. Additionally, all plants produce a wide range of secondary metabolites that are not essential for growth but serve as plant growth regulators, stress response modulators, insect pest repellents, antimicrobial compounds, and the like. Secondary plant metabolites commonly fall into four classes; terpenes, phenolics, glycosides, and alkaloids.

It is well known that secondary plant metabolites have a broad range of desirable attributes for use in the formulation of personal care and consumption products. Some examples include flavorants, colorants, fragrances, therapeutic medicinal effects, psychotropic and/or psychoactive effects, topical antiseptics, and the like.

Methods for extraction and recovery of secondary plant metabolites are well known and generally comprise the steps of (i) harvesting and recovering a selected portion of plant biomass such as flowers and/or seeds and/or leaves and/or stems or roots, (ii) processing the harvested plant biomass by drying, (iii) comminuting the processed plant biomass into powders or granules or pellets, (iv) immersing the comminuted plant biomass in a solvent under selected temperature and pressure conditions for selected periods of time, and then (v) separating the plant biomass solids from the solvent that contain therein extracted secondary plant metabolites. Common solvent extraction methods using water include hot water extraction under ambient pressure, pressurized hot water extraction, subcritical water extraction, supercritical water extraction, among others. Non-aqueous subcritical or supercritical fluid solvents, such as carbon dioxide, are also commonly used to extract secondary plant metabolites. Other common extraction methods are based on the use of hydrocarbon-based solvents including alcohols, alkanes, aldehydes, and the like. Some solvent extract methods include additional steps such as ultrasonication, microwave irradiation, ohmic resistance, among others.

Such extraction processes are characterized by physical and chemical disruption of plant cells thereby releasing secondary plant metabolites from within the cells, from cell membranes, and from cell walls to thereby produce complex mixtures of solubilized plant metabolites along with their organic precursors, breakdown products, anions, cations, and other plant constituents. Such complex mixtures are commonly referred as crude extracts. It is common practice for use of crude extracts in some product formulations prepared for topical applications or for oral consumption. Many processes have been developed and used for refining crude plant extracts to separate out and concentrate and optionally purify selected types of plant secondary products to derive more value from crude extracts.

It is well known that plants have a well-established propensity to take up metals from their soil environment and to sequester metals in their cells, cell membranes and cell walls as organic metal complexes. Due to their organic nature, the metal-bearing compounds sequestered in plant tissues are readily extracted with organic secondary plant metabolites during conventional solvent extraction processes. Consequently, crude plant extracts have a significant risk of containing toxic heavy metals. This is further exacerbated when extracts are prepared from plants grown in soils with elevated heavy metals concentrations. Additionally, the conventional uses for plant extracts often regulate the total amount of heavy metals in the final product composition. Reducing the heavy metals content of plant extract ingredients is essential for manufacturers of pharmaceutical, nutraceutical, cosmetic and cannabis products to provide safe products to consumers and meet the established regulatory limitations on heavy metals in their final product compositions.

### BRIEF SUMMARY

One or more embodiments of the present disclosure generally relate to methods for pretreating plant material to immobilize and/or sequester therein inherent metals and heavy metals, prior to extracting the pretreated plant material with selected solvents.

Some of the embodiments disclosed herein, pertain to methods wherein selected plant materials are comminuted to selected particle sizes, followed by spreading of the comminuted plant material into a layer having a selected thickness. A non-ionizing radiation at an energy input of about equal to or greater than 0.02 kWh per about 1 kg of dried plant material is then applied to the layer of comminuted plant material for a period of time selected from a range of about 15 sec to 10 min. According to an aspect, a resting or cooling period may be provided for a selected period of time after the application of the non-ionizing radiation. According to another aspect, the cycle of non-ionizing radiation followed by a resting or cooling period, may be repeated for one or more times.

Another embodiment disclosed herein pertains to providing cooling to the layered comminuted plant material during the one or more non-ionizing radiation and resting cycles. The cooling may be provided by conducting the non-ionizing radiation/resting cycles within a refrigerated facility. According to some aspects, the cooling may be provided by distributing the layer of comminuted plant material on a temperature-controllable surface within a chamber wherein the non-ionizing radiation/resting cycles occur.

### BRIEF DESCRIPTION OF THE FIGURES

The embodiments of the present disclosure will be described with reference to the following drawings in which:

FIG. 1 is a chart showing the effects of electromagnetic treatment temperatures on heavy metal immobilization in plant matter;

FIG. 2 is a chart showing the effects of different types of non-ionizing radiation treatments of plant matter on the immobilization of heavy metals therein;

FIG. 3 is a chart showing the effects of a method according to one embodiment of the present disclosure on the leachability of various heavy metals from plant material; and

FIG. 4 is a chart showing the effects of microwave radiation on the leachability of lead in uncontaminated and lead-contaminated plant matter.

### DETAILED DESCRIPTION

The embodiments of the present disclosure generally relate to methods for pretreating plant material to immobilize and sequester inherent metals therein, to thereby minimize or prevent the immobilized, sequestered metals from solubilization during solvent processing of the pretreated plant material.

The methods of one or more embodiments of the present disclosure may provide a number of advantages. For example, a first advantage includes the immobilizing and/or sequestering of metals assimilated within the plant material, to thereby reduce or prevent the assimilated metals from being extracted during subsequent solvent extraction processes. As may be appreciated, by reducing or preventing metals such as heavy metals from being extracted during such solvent extraction processes, fewer or no post-extraction processes may be required to remove metals from the extracts in order to render them suitable for use in, for example, cosmetics, food, beverages, and other product formulations for topical application or oral consumption. Conventional processes for removing metals from extracts typically involve additional processing using a variety of chemical reagents. The methods according to one or more embodiments disclosed herein may avoid the necessity of such additional processing steps and thereby reduce the amount of chemical waste produced and the associated costs and disposal issues.

Another advantage of the methods according to one or more embodiments of the present disclosure is that they may be scalable to industrial throughput volumes using existing available equipment. That is, manufacturers need not invest in overly expensive, specialized equipment to perform the methods of the present disclosure.

Yet another advantage of the methods according to one or more embodiments of the present disclosure is that they may preserve secondary metabolites contained in plant material. That is, the methods according to one or more embodiments of the present disclosure are capable of immobilizing and sequestering the metals and heavy metals assimilated into the plant material without degrading the content of secondary metabolites contained therein. As will be appreciated, secondary plant metabolites include phytochemicals or bioactive compounds that are divided into four major classes common to most plants, namely, terpenes, phenolics, glycosides and alkaloids. Some plants, such as hops or cannabis, include secondary metabolites that belong to two or more of the major classes. For example, cannabinoids are terpenophenolic compounds.

As used herein, the terms “plant matter” and “plant material” refer to material derived from whole plants. For example, the plant matter may include leaves, flowers, buds, stems, branches, roots, rhizomes, seeds, fruit, plant processing byproducts, or combinations thereof. Suitable plant processing byproducts include seed cakes, pulps, peels, hulls, or the like.

As used herein, the term “comminuting” means reducing the plant material into particles or granules or pellets by a process such as cutting, shredding, sieving, grinding, milling, and the like. Suitable equipment for comminuting plant materials include hammer mills, vibration mills, impact mills, attrition mills, grinders, and the like.

As used herein, “plant metabolites” include organic and inorganic compounds produced and assimilated during plant metabolism and growth. Plant metabolites include primary and secondary metabolites. Primary metabolites are essential for plant growth and may include fatty acids, amino acids, monosaccharides, disaccharides, polysaccharides, and the like. Secondary metabolites are generally not essential for plant growth, but instead typically serve to regulate plant biochemistry, repel herbivores, attract pollinators, and the like. Secondary metabolites are desired across a variety of industries and find use in natural flavors, fragrances, and therapeutic, medicinal and/or psychoactive pharmaceutical products. Secondary metabolites may be divided into four main categories: terpenes, phenolics, glycosides, alkaloids. However, certain secondary metabolites, such as terpenophenolic compounds, may fall into more than one category.

As used herein, the term “solvent extraction” refers to a process solubilizing plant metabolites and constituents from a selected plant material by contacting the plant material with one or more solvents.

As used herein, the term “non-ionizing radiation” refers to electromagnetic radiation that does not cause the removal of electrons from atoms or molecules. Examples of non-ionizing radiation include microwaves, infrared waves (IR), visible light waves, and radio waves.

As used herein, “energy input” means the amount of energy delivered by way of the non-ionizing radiation to the plant material. In the methods of the present disclosure, energy is delivered to the plant material to thereby induce the chemical bonding of any metals contained in the plant material to thereby immobilize and sequester the metals to minimize or prevent the solubilization of the metals during subsequent solvent extraction processes.

As used herein, the term “immobilize” means that the metals present in plant material are chemically bonded such that their leachability is reduced or that they are rendered substantially non-leachable.

As used herein, “leaching” refers to partitioning of metals from plant material by percolation of a solvent therethrough.

As used herein, the term “leachable” refers to whether or not an immobilized metal can be partitioned and solubilized from a plant material by percolation of a solvent therethrough.

Reference will now be made in detail to example embodiments of the disclosure, wherein numerals refer to like components, examples of which are illustrated in the accompanying drawings that further show example embodiments, without limitation.

One embodiment of the present disclosure pertains to a method of pretreating a dried plant material prior to solvent extraction. The method comprises comminuting a selected dried plant material to particle sizes that are equal to or less than about 20 mm, spreading the comminuted plant material into a layer having a thickness of no more than about 5 times of the particle sizes of the comminuted plant material, for example into a layer having a thickness of about 100 mm or less, and then exposing the layer of comminuted plant material to a non-ionizing radiation at an energy input of equal to or greater than about 0.02 kWh per 1 kg of dried plant material.

Another embodiment of the present disclosure pertains to methods for pretreating a selected dried plant material, prior to solvent extraction, by comminution. Comminuting dried plant material fractures the plant material into granules and particles and then, further decreases the particle size thereof. Comminution significantly increases surface area exposure of plant materials thereby facilitating the penetration of the non-ionizing radiation into the comminuted plant material. According to one aspect, the plant material may be comminuted to an average particle size of about 10 mm to about 20 mm. According to another aspect, the plant material may be comminuted to a particle size of about 10 mm or less. According to some aspects, the comminuted plant material may be spread into layers having a thickness that is about 5 times the average particle size of the comminuted plant material, or less. For example, a comminuted plant material having an average size of about 20 mm may be spread into layers having a thickness of about 100 mm or less. A comminuted plant material having an average size of about 10 mm may be spread into layers having a thickness of about 50 mm or less. According to other aspects, the comminuted plant material may be spread into layers having a thickness that is about 3 times the average particle size of the comminuted plant material, or less. For example, a comminuted plant material having an average size of about 20 mm may be spread into layers having a thickness of about 60 mm or less. A comminuted plant material having an average size of about 10 mm may be spread into layers having a thickness of about 30 mm or less.

According to another embodiment, the non-ionizing radiation may have a frequency of about 0.3 GHz to about 430,000 GHz. Such a frequency range generally encompasses IR and microwave radiation waves. In such aspects, the non-ionizing radiation may be generated using, for example, power grid tubes, magnetrons, klystrons, travelling wave tubes, gyrotrons, low-power-density ceramic radiator elements, carbon-fiber radiator elements, and the like. In some aspects, the non-ionizing radiation may be directed into the plant material by way of one or more waveguides. The waveguide(s) may be any suitable type known in the art. For example, the one or more wave guides may comprise an aluminum H-bend waveguide, a sheet metal waveguide, and the like. In a further aspect, the non-ionizing radiation has a frequency of about 0.3 GHz to about 20,000 GHz and comprises microwave and far-IR radiation.

According to one aspect, the plant material is subjected to non-ionizing radiation at an energy input of greater than or equal to about 0.1 kWh per 1 kg of dried plant material. As described above, the energy input is selected to immobilize any metals present in the plant material to thereby render the metals substantially non-solubilizable and/or non-leachable during subsequent solvent extractions. Further, it is noted that, as used herein, “dried” material refers to plant material having a water content of about 15% or less by weight (w/w). In one aspect, the dried plant material may have a water content of 10% or less by weight (w/w). In another aspect, the dried plant material may have a water content of 5% or less by weight (w/w).

Without being bound to a particular theory, subjecting the plant matter to non-ionizing radiation without rupturing the cells thereof may induce the chemical bonding of any metals present therein such that they are immobilized during subsequent extractions. In more detail, it was found that the rupture of plant cells releases the metal contents contained therein, thereby rendering the metal contents extractable with the desired products.

However, in some aspects, the energy input may be selected such that the energy provided is enough to heat and the rupture cells of the plant material if other operational parameters are not adjusted. Thus, in such aspects, in the methods of the present disclosure may comprise steps for maintaining the cellular structures of the plant material during subjection to the non-ionizing radiation. The cells may be maintained by, for example, controlling the temperature of the plant material, selecting specific types of non-ionizing radiation.

For example, in one aspect, the subjecting of the plant material to the non-ionizing radiation comprises maintaining the temperature of the plant material at or below about 70° C. Maintaining such temperatures will reduce the likelihood of the cells of the plant material rupturing while also reducing the likelihood of damage to extractable products including secondary metabolites. In a further aspect, the subjecting of comminuted plant material to non-ionizing radiation comprises maintaining the temperature of the plant material at or below about 60° C.

In some aspects, the maintaining of the temperature of the plant material comprises intermittently subjecting the plant material to the non-ionizing radiation. That is, the non-ionizing radiation may be applied for selected time periods after which, it is turned off for selected time periods to allow the plant material to cool between applications of the radiation. For example, the non-ionizing radiation may be cycled by applying radiation for about 15 seconds to about 60 seconds, then turning the radiation off for about 15 seconds to about 60 seconds (for a “resting” or a cooling period), and then repeating this radiation/resting cycle for a selected number of cycles. Suitable numbers of cycles may be selected from a range of 1 to 20 cycles, therebetween, or more. If so desired, the resting period may be selected from a range of about 30 sec to about 10 min, and therebetween.

In a further aspect, maintenance of the plant material temperature comprises cooling the layered comminuted plant material during application of the non-ionizing radiation and/or during the resting period, or throughout the cycle. Suitable methods of cooling the layered comminuted plant material include conducting the non-ionization radiation process within a refrigerated room that is maintained at a temperature selected from about −10° C. to about 15° C. Alternatively, the non-ionization radiation process may be conducted within an insulated chamber having a temperature-controlled bottom surface onto which the comminuted plant materials may be layered. The temperature-controlled bottom surface of the chamber may be controllable at a temperature selected from a range of about −20° C. to about 15° C.

It is further noted that, in aspects where the non-ionizing radiation is directed to the plant material by way of a waveguide, the temperature of the plant material may be regulated by configuring the waveguide to act as a heat sink. For example, if the waveguide is formed of a metal (for example, a sheet metal), the waveguide may act as a heat sink to absorb at least a portion of the heat generated by the radiation.

Further, in some embodiments, the methods for pretreating the plant material prior to solvent extraction further comprise arranging the plant material in a layer having a thickness of less than or about 5 times the average particle size of the plant material. That is, the plant material may be physically arranged to form a layer of plant material to thereby facilitate even subjection of the plant material to the non-ionizing radiation. According to one aspect, the layer has a thickness of less than or about 3 times the average particle size of the plant material. In some aspects, the layer of plant material may be maintained within non-ionizing radiation transparent material. For example, in some aspects, the layer of plant material may be disposed between two or more pieces of non-ionizing radiation transparent material such as rigid polymer sheets.

Another embodiment of the present disclosure relates to a method of extracting products from a plant material, the method comprising: pretreating the plant material using the methods previously described herein; contacting the plant material with a solvent to solubilize secondary plant metabolites thereinto to thereby produce a plant extract; and recovering the plant extract from the extracted plant material.

According to one aspect, the contacting the plant material with a solvent comprises infusing the plant material with the solvent for about 24 hours. By “infusing”, it is meant that the plant materials are coated with or soaked in the solvent to thereby extract desired products therefrom. As previously described herein, the solvent is used to dissolve products such as phytochemicals or bioactive substances contained in the plant material. The solvent may be any suitable hydrocarbon solvent such as an alcohol, an alkane, and aldehyde, the like, and suitable mixtures thereof. According to an aspect, the solvent may comprise denatured ethanol. According to another aspect, the solvent may be one of subcritical water or supercritical water. According to another aspect, the solvent may be one of subcritical CO₂ or supercritical CO₂.

### EXAMPLES

### Example 1: Effect of Infrared (IR) Treatment Energy and Temperature on the Immobilization of Heavy Metals in Hemp Leaves

Dried leaves from cultivated industrial hemp plants were comminuted to produce particles by vibration and sieving through a 2.5 mm sieve. The comminuted plant matter was arranged in a thin layer having a thickness of about 5 mm. The layer was disposed between two layers of IR transparent acrylic polymer.

IR radiation was generated by incandescent tungsten filaments lamps and directed into the layer of plant matter by way of a sheet metal waveguide. The sheet metal waveguides direct the radiation into the layer of plant material at the required energy input as well as act as a heat sink to control the temperature of the plant material. As well, cooling fans were used to further cool the waveguide and the layers of IR transparent acrylic, to thereby further control the temperature of the plant material.

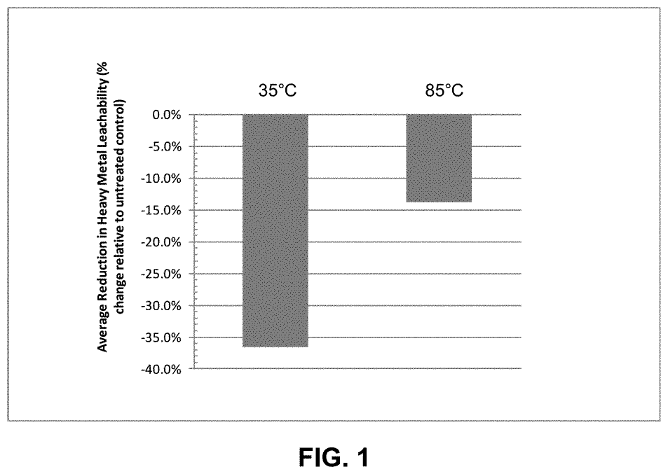

As shown in FIG. 1, in the first and second tests, the plant material temperature was controlled at about 35° C. and about 85° C., respectively, and the energy input into both samples was at least 0.1 kWh per kg of dried plant material.

After treatment with IR radiation, the plant material was subjected to solvent extraction using denatured ethanol. The solvent extraction was performed as an infusion with about 8 parts solvent to 1 part plant material by mass, at approximately 20° C. for 24 hours. After the 24-hour period, a miscella (a mixture of extract and solvent) was filtered through 25 μm filter paper to remove particulate matter. The filtrate was analyzed by inductively coupled plasma mass spectrometry (ICP-MS) to detect and determine heavy metal concentrations.

Eleven (11) heavy metals ranging in atomic mass from approximately 50 to 240 atomic mass units (amu) and specific gravities ranging from approximately 5.7 to 19 were detected by ICP-MS in the miscella. The metals analyzed included: antimony (Sb), arsenic (As), cadmium (Cr), chromium (Cr), copper (Cu), lead (Pb), manganese (Mn), mercury (Hg), silver (Ag), uranium (U) and zinc (Zn).

The heavy metal concentrations in the miscella were compared to a control miscella obtained from similar plant material that was not subject to IR radiation treatment. The relative change in average miscella heavy metal concentration between the IR treated miscella and the control miscella were compared.

As shown FIG. 1, IR radiation treatment of the plant material controlled at about 35° C., reduced the average heavy metals concentration in the miscella by about 37% as compared to the control. In comparison, the average reduction of the heavy metals concentration in the miscella treated with IR radiation at a temperature of about 85° C. was substantially reduced to about 14%, as compared to the control.

### Example 2: Immobilization of Heavy Metals in Hemp Leaves Using Different Types of Non-Ionizing Radiation, Energy Inputs, and Treatment Temperatures

Electromagnetic waves from the UV-A, visible light, IR, and microwave portions of the non-ionizing radiation spectrum were assessed for effectiveness in immobilizing heavy metals in plant matter over a range of energy inputs and treatment temperatures in their respective preferred and required regimes.

Each experimental set-up included an electrically powered wave source, a waveguide to direct the electromagnetic waves to the plant matter sample, a sample holder to contain the hemp leaves sample in a thin bed, a physical enclosure to contain the treatment waves and sample, thermocouples, and a means of controlling sample temperature comprising intermittent wave source operation, heat sinks, cooling fans and/or refrigeration. The electromagnetic wave generators used during the experiments were magnetrons for microwaves, low power density ceramic radiator elements for far-IR radiation, high power density tungsten filament radiator elements for mid- and short-IR radiation, full visible light spectrum LED light bulbs for visible light, and UV-A emitting bulbs for UV-A radiation. The hemp leaf samples were prepared in the same manner as described above in Example 1.

After treatment, the hemp leaf samples were subjected to solvent extraction using denatured ethanol. Solvent extraction was performed as an infusion with 8 parts solvent to 1 part sample by mass, at approximately 20° C. for 24 hours. After 24 hours, the miscella was filtered through 25 μm filter paper to remove particulate material and then analyzed for heavy metal concentrations. Heavy metal concentrations were determined by ICP-MS. The metals analyzed included antimony (Sb), arsenic (As), cadmium (Cr), chromium (Cr), copper (Cu), lead (Pb), manganese (Mn), mercury (Hg), silver (Ag), uranium (U) and zinc (Zn).

The heavy metal concentrations in the miscella were compared to a control miscella obtained from similar plant material that was not subject to radiation treatment. The relative change in miscella heavy metal concentration between the treated samples and untreated samples were compared.

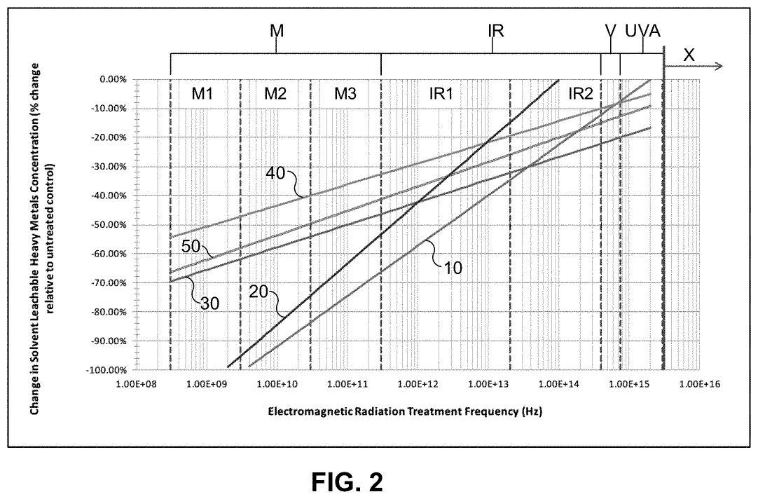

Referring to FIG. 2, the results of the experiments are illustrated, wherein M indicates the microwave frequency range, IR indicates the IR frequency range, V indicates the visible light frequency range, and UVA indicates the UV-A frequency range. Further, the microwave frequency range is subdivided into sections M1, M2, and M3, which indicate the ultra high frequency UHF, super high frequency (SHF), and extremely high frequency (EHF) bands, respectively. Similarly, the IR frequency range is subdivided into sections IR1 and IR2, which indicate the far-IR frequency and the remaining IR frequency bands, respectively. In addition, the reference character X indicates the ionizing radiation spectrum.

As shown in FIG. 2, Microwave and far-IR radiation were the most effective at immobilizing heavy metals in the samples. The heavy metals are indicated using the following reference characters:

| Heavy Metal | Reference Character |
|---|---|
| Lead (Pb) | 10 |
| Zinc (Zn) | 20 |
| Manganese (Mn) | 30 |
| Copper (Cu) | 40 |
| Average of Sb, As, Cd, Cr, | 50 |
| Cu, Pb, Mn, Hg, Ag, U, Zn | |

Lead is the most studied heavy metal contaminant and represents one of the most significant contaminants of concern to the environment and human health. The ICP-MS test method used to determine the heavy metal concentrations in the miscella had a detection limit of approximately 2 ppb. The use of microwaves in the upper UHF/lower SHF portion of the microwave spectrum effectively reduced the concentration of lead in the miscella to the equipment detection limit of 2 ppb. With regards to human health considerations, drinking water guidelines generally have the most stringent limitations on heavy metal concentrations. In Canada and the US, the amount of lead in drinking water is limited to 5 ppb and 15 ppb, respectively.

### Example 3: Immobilization of Heavy Metals Having a Specific Gravity of Greater than 5.0 in Hemp Leaves Using Non-Ionizing Radiation

The effectiveness of types of non-ionizing radiation in immobilizing heavy metals in hemp leaves was assessed relative to the atomic mass of the individual heavy metal. It is noted that the hemp leaf samples were prepared as described above in Example 1.

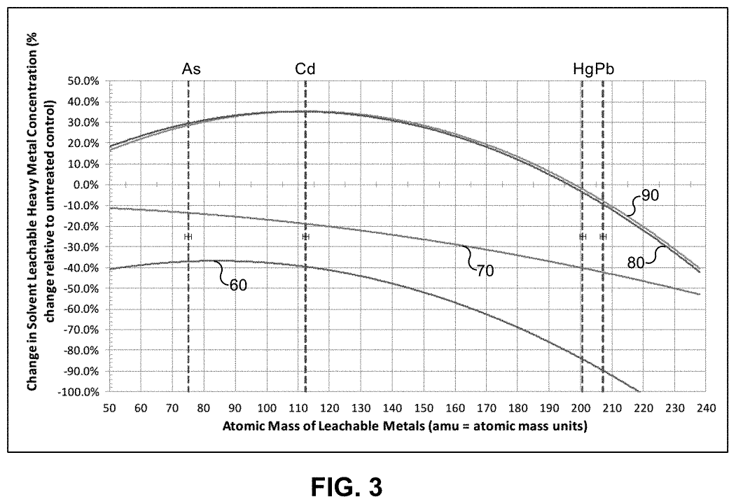

Referring to FIG. 3, the lines labelled 60, 70, 80, and 90 illustrate the effects of microwave radiation, IR radiation, UV-A radiation, and visible light radiation, respectively. The atomic masses of arsenic (As), cadmium (Cd), mercury (Hg), and lead (Pb) are indicated for reference.

As shown in FIG. 3, IR radiation treatment exhibited significant reduction of heavy metal leachability, that is, an increase in the immobilization of metals in the samples. As well, microwave radiation treatment exhibited substantial immobilization of heavy metals in the samples, especially heavy metals with higher atomic masses including those such as lead and mercury. For example, by using microwave radiation, the concentration of lead in the miscellas obtained from the treated samples was reduced to about undetectable levels.

### Example 4: Immobilization of Leachable Lead in Industrial Hemp Plants Using Microwave EMR Treatment

The effectiveness of microwave EMR radiation in immobilizing leachable lead was assessed in sprouted industrial hemp plants grown in uncontaminated and lead-contaminated soil.

To prepare the industrial hemp plants, the seeds were first germinated for 3 days. A first set of seeds (“uncontaminated seeds”) were germinated in distilled water. A second set of seeds (“lead-contaminated seeds”) were germinated in an aqueous lead solution having a 1,100 ppm ionic lead content.

After the 3-day germination period, the germinated seeds were transferred to uncontaminated and lead-contaminated growth mediums. The uncontaminated seeds were transferred to an uncontaminated growth medium that contained no added lead and less than 25 ppm of lead in total. The lead-contaminated seeds were transferred to a lead-contaminated growth medium that contained 1,100 ppm of added dissolved lead (1,100 mg of lead per kg of growth medium). The industrial hemp plants were grown in the uncontaminated and contaminated mediums for 17 days under ambient conditions, with direct sunlight exposure and daily watering.

After the 17 days, the plants were harvested, air dried to approximately 10% moisture by mass, and shredded to an average particle size of approximately 5 mm to produce plant matter samples. Uncontaminated plant matter and lead-contaminated plant matter were each subjected to microwave EMR with at least 0.1 kWh/kg energy input, and with the power source cycling to maintain the plant matter temperature below 60° C.

Untreated uncontaminated and lead-contaminated plant matter and microwave-treated uncontaminated and lead-contaminated plant matter were then subjected to denatured ethanol extraction and ICP-MS analysis of the miscella.

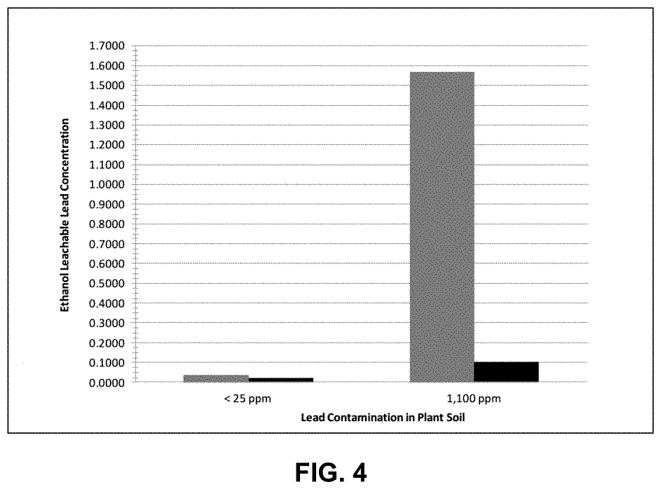

The results of ICP-MS analyses are shown in FIG. 4, which shows the ethanol leachable lead concentration of the untreated and microwave-treated uncontaminated plant matter (indicated as “>25 ppm”) and the untreated and microwave-treated lead-contaminated plant matter (indicated as “1,100 ppm”). The grey bars represent the untreated plant matter and the black bars represent the microwave-treated plant matter in both cases.

The ethanol leachable lead concentration of the untreated uncontaminated plant matter was 0.0356 ppm, while the ethanol leachable lead concentration of the microwave-treated uncontaminated plant matter was 0.0224 ppm.

The ethanol leachable lead concentration of the untreated lead-contaminated plant matter was 1.5682 ppm, while the ethanol leachable lead concentration of the microwave-treated lead-contaminated plant matter was 0.1023 ppm.

Thus, in both bases, microwave treatment reduced the leachable lead content of the plant matter. In the lead-contaminated plant matter, the leachable lead content was reduced by 93%.

In the present disclosure, all terms referred to in singular form are meant to encompass plural forms of the same. Likewise, all terms referred to in plural form are meant to encompass singular forms of the same. For example the articles “a” and “an” are used herein to refer to one or to more than one (i.e., to at least one) of the grammatical object of the article. Unless defined otherwise, all technical and scientific terms used herein have the same meaning as commonly understood by one of ordinary skill in the art to which this disclosure pertains.

The preceding examples can be repeated with similar success by substituting the generically or specifically described reactants and/or operating conditions of this invention for those used in the preceding examples.

Note that in the specification and claims, “about” or “approximately” means within twenty percent (20%) of the numerical amount cited.

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A method for pretreating a plant material prior to solvent extraction, the method comprising:
comminuting a dried plant material;
spreading the comminuted dried plant material into a layer; and
subjecting the layered comminuted plant material to non-ionizing radiation at an energy input of equal to or greater than about 0.02 kWh per 1 kg of dried plant material for a period of time selected from a range of about 15 sec to about 10 min.

2. The method of claim 1, additionally comprising a resting period following the non-ionization radiation, said resting period selected from a range of about 15 sec to about 10 min.

3. The method of claim 2, additionally comprising one or more cycles of the non-ionization radiation and resting period.

4. The method of claim 1 wherein the plant material is comminuted to an average particle size of about 20 mm or less.

5. The method of claim 1 wherein the plant material is comminuted to an average particle size of about 10 mm or less.

6. The method of claim 1 wherein a thickness of the layered comminuted plant material is about five times an average particle size of the comminuted plant material, or less.

7. The method of claim 1 wherein the thickness of the layered comminuted plant material is about three times an average particle size of the comminuted plant material, or less.

8. The method of claim 1 wherein the comminuting comprises one of cutting, shredding, sieving, or milling.

9. The method of claim 8, wherein the milling comprises one of impact milling, vibrational milling, or attrition milling.

10. The method of claim 1 wherein the non-ionizing radiation has a frequency of about 0.3 GHz to about 430,000 GHz.

11. The method of claim 1, wherein the non-ionizing radiation has a frequency of about 0.3 GHz to about 20,000 GHz.

12. The method of claim 1 wherein the plant material is subjected to the non-ionizing radiation at an energy input of equal to or greater than about 0.1 kWh per 1 kg of dried plant material.

13. The method of claim 1 wherein the subjecting of the plant material to the non-ionizing radiation comprises maintaining a temperature of the plant material at or below about 70° C.

14. The method of claim 13, wherein the subjecting of the plant material to the non-ionizing radiation comprises maintaining the temperature of the plant material at or below about 60° C.

15. The method of claim 1 wherein the subjecting the layered comminuted plant material to non-ionizing radiation is done within a temperature-controlled environment.

16. The method of claim 15, wherein a temperature within the temperature-controlled environment is selected from a range of about −20° C. to about 15° C.

17. The method of claim 1 wherein the plant material comprises leaves, flowers, buds, stems, branches, roots, rhizomes, seeds, fruit, plant processing byproducts, or combinations thereof.

18. The method of claim 17, wherein the plant processing byproducts comprise seed cakes, pulps, peels, hulls, or combinations thereof.

19. The method of claim 1 wherein the plant material is dried to a moisture content of about 15% w/w or less.

20. A pretreated plant material produced by the method of claim 1.

21. A method of extracting products from a plant material, the method comprising:
pretreating the plant material according to the method of claim 1;
contacting the pretreated plant material with a solvent for a selected period of time to thereby produce a solvent-solubilized plant extract; and
separating and recovering the solvent-solubilized plant extract from the pretreated plant material.

22. The method according to claim 21, wherein the solvent is one of water or a non-aqueous solvent.
